(19) United States
(12) Patent Application Publication
(10) Pub. No.: US 2018/0329452 A1
(43) Pub. Date: Nov. 15, 2018

(54) VIRTUAL REALITY DEVICE AND SYSTEM

(71) Applicant: BOE TECHNOLOGY GROUP CO., LTD., Beijing (CN)

(72) Inventor: Bo ZHANG, Beijing (CN)

(21) Appl. No.: 15/500,734

(22) PCT Filed: Jun. 29, 2016
(86) PCT No.: PCT/CN2016/087689

§ 371 Date: Jan. 31, 2017

(30) Foreign Application Priority Data
Mar. 22, 2016 (CN) 201610166649.X

(51) Int. Cl. G06F 1/16; G06T 19/00

(52) U.S. Cl. CPC G06F 1/163; G02B 5/005; G06F 1/1637; G06T 19/006

(57) ABSTRACT

A virtual reality (VR) device and a VR system are provided. The VR device includes an optical system and a cabin. The cabin is configured such that an electronic device provided with a display can be detachably mounted therein. The optical system is configured for imaging of light emitted by the display. The VR device and the VR system utilize hardware and software resources of the electronic device provided with the display, do not require an independent display, reduce the hardware cost, and meanwhile, provide convenience for acquiring application resources.

### TECHNICAL FIELD

Embodiments of the present invention relate to a virtual reality (VR) device and a VR system.

### BACKGROUND

With the continuous progress of electronic science and technology, VR is a high-tech emerging in recent years.

The current VR system mainly simulates a virtual three-dimensional (3D) world through a high-performance computing system provided with a central processing unit (CPU) and provides users with visual, auditory and other sensory experience, so that the users can have an immersed sense and can be interactive.

### SUMMARY

The embodiments of the disclosure provide a virtual reality (VR) device, comprising an optical system and a cabin, wherein the cabin is configured such that an electronic device provided with a display can be detachably mounted therein; and the optical system is configured for imaging of light emitted by the display.

For example, in a VR device provided by an embodiment of the disclosure, the optical system includes a first optical system and a second optical system; light emitted by a first area of the display is imaged to a left eye of a user through the first optical system; and light emitted by a second area of the display is imaged to a right eye of the user through the second optical system.

For example, in a VR device provided by an embodiment of the disclosure, the cabin is also provided with a transmission member matched with a camera of the electronic device; the camera of the electronic device is capable of acquiring an ambient image through the transmission member; and the electronic device is configured to generate a composite image by overlapping the ambient image and a virtual scene and display the composite image on the display.

For example, in a VR device provided by an embodiment of the disclosure, a focal length, an object distance and an interpupillary distance of the first optical system and the second optical system are adjustable.

For example, in a VR device provided by an embodiment of the disclosure, both the first optical system and the second optical system are eyepiece systems.

For example, in a VR device provided by an embodiment of the disclosure, the cabin further includes a built-in camera, a motor and a processor; the built-in camera is configured to acquire an eye image of the user; the processor is configured to acquire proper focal length, object distance and interpupillary distance by analyzing the eye image; and the processor is also configured to control the motor to automatically adjust the focal length, the object distance and the interpupillary distance of the first optical system and the second optical system.

For example, in a VR device provided by an embodiment of the disclosure, the first optical system and the second optical system further include a first aperture stop and a second aperture stop respectively.

For example, in a VR device provided by an embodiment of the disclosure, the cabin further includes a light-shielding plate disposed between the first optical system and the second optical system.

For example, in a VR device provided by an embodiment of the disclosure, the cabin is made of an opaque material.

For example, in a VR device provided by an embodiment of the disclosure, the cabin is provided with a window for transmission of imaged light of the optical system.

For example, in a VR device provided by an embodiment of the disclosure, the cabin further comprises a light shield.

For example, in a VR device provided by an embodiment of the disclosure, the cabin further includes an elastic fixing member; a first end of the elastic fixing member is connected with the cabin; and a second end of the elastic fixing member is capable of being connected with the electronic device.

For example, in a VR device provided by an embodiment of the disclosure, the cabin is provided with a cabin cover which is capable of being opened or closed, or a notch is formed on a side of the cabin.

For example, in a VR device provided by an embodiment of the disclosure, the cabin further includes an interface for audio transmission with the electronic device.

For example, in a VR device provided by an embodiment of the disclosure, the cabin further includes a heat dissipation structure; a first side of the heat dissipation structure makes contact with the electronic device; and a second side of the heat dissipation structure is disposed on an outside surface of the cabin.

For example, a VR device provided by an embodiment of the disclosure further comprises a head mounting member, wherein the head mounting member includes bands which are at least connected with two opposite sides of the cabin.

For example, in a VR device provided by an embodiment of the disclosure, the head mounting member includes a first band, a second band and a third band, in which a first end of the first band is connected with a first side of the cabin; a first end of the second band is connected with a second side of the cabin; a first end of the third band is connected with a top of the cabin; and a second end of the first band, a second end of the second band and a second end of the third band are respectively provided with a first connecting member, a second connecting member and a third connecting member, and are capable of being connected with one another through the first connecting member, the second connecting member and the third connecting member.

Embodiments of the disclosure further provide a VR system, comprising the VR device according to any embodiment of the disclosure and an electronic device provided with a display, wherein the electronic device is mounted in the cabin.

For example, in a VR system provided by an embodiment of the disclosure, the electronic device is a smart mobile phone or a tablet computer.

For example, a VR system provided by an embodiment of the disclosure further comprises a battery, wherein the battery is electrically connected with the camera, the motor and the processor.

### BRIEF DESCRIPTION OF THE DRAWINGS

For more clear understanding of the technical proposals of the embodiments of the present invention, simple description will be given below to the accompanying drawings required to be used in the embodiments and relevant description. Obviously, the drawings described below only involve some embodiments of the present invention but are not intended to limit the present invention.

FIG. 1 is a schematic diagram of a VR device provided by one embodiment of the present invention;

FIG. 2 is a schematic diagram of an elastic fixing member in the VR device provided by one embodiment of the present invention;

FIG. 3 is a schematic diagram of an elastic fixing member in the VR device provided by one embodiment of the present invention;

FIG. 4 is a schematic diagram of a head mounting member in the VR device provided by one embodiment of the present invention;

FIG. 5 is a schematic diagram of a head mounting member in the VR device provided by one embodiment of the present invention;

FIG. 6 is a schematic diagram when a user wears the head mounting member as shown in FIGS. 4 and 5;

FIG. 7 is a schematic diagram when the user wears the head mounting member as shown in FIGS. 4 and 5; and

FIG. 8 is a schematic diagram of a VR device provided by another embodiment of the present invention.

### DETAILED DESCRIPTION

Clear and complete description will be given below to the technical proposals in the embodiments of the present invention with reference to the accompanying drawings. The preferred embodiments of the present invention and various characteristics and favorable details thereof are more fully explained with reference to the non-limiting preferred embodiments shown in the accompanying drawings and described below in details. It should be noted that the characteristics shown in the figures are not required to be drawn proportionally. The present invention omits the description on known materials, components, processes and technologies, so that the preferred embodiments of the present invention can be clear. The given examples are only intended to facilitate the understanding of the implementation of the preferred embodiments of the present invention, so that those skilled in the art can implement the preferred embodiments. Therefore, the embodiments shall not be construed as the limitation of the scope of the embodiments of the present invention.

Unless otherwise specified, the technical terms or scientific terms used in the present invention shall have normal meanings understood by those skilled in the art. The words “first”, “second” and the like used in the present invention do not indicate the sequence, the number or the importance but are only used for distinguishing different components. In addition, in the embodiments of the present invention, same or similar reference numerals indicate same or similar members.

In relevant technology, a VR system must be equipped with an independent display, and application resources (e.g., movies and games) of the VR system must be acquired from an external device (e.g., a mobile phone and a computer). The VR system has high hardware cost, is expensive and is inconvenient to acquire the application resources.

Embodiments of the present invention provide a VR device and a VR system. The VR device comprises an optical system and a cabin. An electronic device (e.g., a smart mobile phone and a tablet computer) provided with a display can be detachably mounted in the cabin. The optical system is used for the imaging of light emitted by the display.

The VR device and the VR system provided by the embodiment of the present invention utilize hardware and software resources of the electronic device provided with the display, do not require an independent display, reduce the hardware cost, and meanwhile, provide convenience for acquiring application resources.

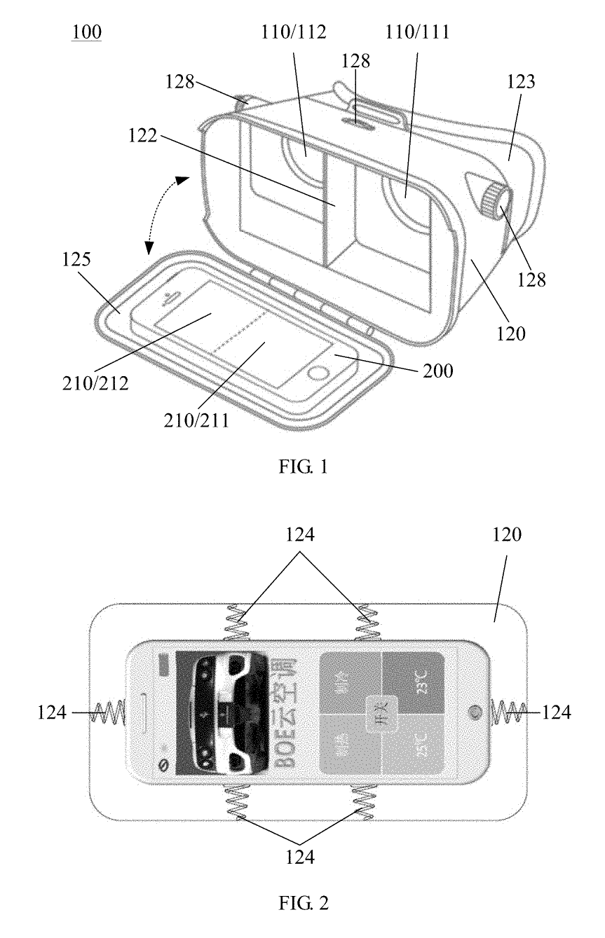

The embodiment of the present disclosure provides a VR device 100. As illustrated in FIG. 1, the VR device 100 comprises an optical system 110 and a cabin 120. The cabin 120 is configured such that an electronic device 200 provided with a display 210 can be detachably mounted therein. The optical system 110 is configured for the imaging of light emitted by the display 210.

For instance, the electronic device 200 provided with the display 210 can be detachably mounted in the cabin 120 of the VR device 100. When the VR device 100 is used, the electronic device 200 provided with the display 210 is mounted in the cabin 120 of the VR device 100. After use, the electronic device 200 provided with the display 210 may be detached from the cabin 120 of the VR device 120, and the use of the electronic device 200 in other situations cannot be affected. The VR device 100 utilizes the display 210 of the electronic device 200 and application resources in the electronic device 200, does not require an independent display, and hence can reduce the hardware cost. Meanwhile, as the electronic device (e.g., the smart mobile phone and the tablet computer) has rich application resources, it is easy to acquire the application resources.

For instance, as illustrated in FIG. 1, in the VR device 100 provided by one embodiment of the present disclosure, the optical system 110 includes a first optical system 111 and a second optical system 112. Light emitted by a first area of the display 210 is imaged to a left eye of a user through the first optical system 111, and light emitted by a second area 212 of the display 210 is imaged to a right eye of the user through the second optical system 112.

For instance, when used, the display 210 of the electronic device is placed facing the first optical system and the second optical system and perpendicular to optical axes of the first optical system and the second optical system. The position and the dimension of the first area 211 and the second area 212 of the display 210 may be set through software arranged in the electronic device, so that the user can obtain optimum viewing effect.

For instance, in the VR device 100 provided by one embodiment of the present disclosure, the cabin 120 is also provided with a transmission member (not illustrated in the figure) matched with a camera of the electronic device 200; the camera of the electronic device 200 may acquire an ambient image through the transmission member; and the electronic device 200 generates a composite image by overlapping the ambient image and a virtual scene and displays the composite image on the display 210.

For instance, the transmission member is an opening, a polarizer, a lens, a filter or other light-transmitting members.

For instance, the electronic device acquires the ambient image through the camera and generates the composite image by overlapping the ambient image and the virtual scene. The composite image, for instance, may be the composition of characters in the virtual scene and the real-world ambient image, so that the user can sense that the characters in the virtual scene are immersed in the real-world environment. The display 210, for instance, may respectively display the composite images corresponding to the left eye and the right eye of the user after 3D processing in the first area 211 and the second area 212, so that the user can sense the composite images with 3D effect.

For instance, in the VR device 100 provided by one embodiment of the present disclosure, the focal length, the object distance and the interpupillary distance of the first optical system 111 and the second optical system 112 are adjustable.

For instance, due to the adjustment of the focal length, the object distance and the interpupillary distance of the first optical system 111 and the second optical system 112, the wearer can have full-view viewing experience.

For instance, the focal length, the object distance and the interpupillary distance can be adjusted by changing the position of various optical elements in the first optical system and the second optical system. The embodiment of the present disclosure includes but not limited to the adjustment of the focal length, the object distance and the interpupillary distance of the first optical system and the second optical system, and may also include the adjustment of other optical parameters by changing the position of various optical elements in the first optical system and the second optical system.

For instance, in the VR device 100 provided by one embodiment of the present disclosure, both the first optical system 111 and the second optical system 112 are eyepiece systems.

For instance, the embodiment of the present disclosure includes but not limited to the case that the first optical system and the second optical system are eyepiece systems. According to actual application demands, the first optical system and the second optical system may also be other optical systems.

For instance, in the VR device 100 provided by one embodiment of the present disclosure, the cabin 120 also includes a built-in camera, a motor and a processor (not shown in the figure). The built-in camera is configured to acquire an eye image of the user. The processor is configured to acquire proper focal length, object distance and interpupillary distance by analyzing the eye image. The processor is also configured to control the motor to automatically adjust the focal length, the object distance and the interpupillary distance of the first optical system 111 and the second optical system 112.

For instance, the built-in camera acquires the eye image of the user and sends the eye image to the processor for processing, and the processor analyzes the position of, for instance, the eye of the user by image recognition and other algorithms and generates relevant optical parameters such as the focal length, the object distance and the interpupillary distance, and controls the motor to drive the optical elements in the first optical system 111 and the second optical system 112 to automatically adjust the relevant optical parameters such as the focal length, the object distance and the interpupillary distance.

For instance, the cabin 120 further includes a manual adjustment mechanism 128. The relevant optical parameters such as the focal length, the object distance and the interpupillary distance may also be adjusted by the manual adjustment mechanism 128, so that the first optical system 111 and the second optical system 112 can be adapted to the requirements of different users.

For instance, as the eye condition of different users may be different, for instance, as for longsighted users or shortsighted users, the manual adjustment mechanism 128 may be adopted for fine adjustment on the basis of automatic adjustment, so that the user can obtain optimum viewing experience.

For instance, in the VR device 100 provided by the embodiment of the present disclosure, the first optical system 111 and the second optical system 112 also respectively include a first aperture stop and a second aperture stop (not illustrated in the figure).

For instance, the first aperture stop and the second aperture stop may respectively limit the field of the left eye and the right eye of the user, so that the left-eye image displayed by the first area 211 of the display 210 cannot enter the right eye of the user or the right-eye image displayed by the second area 212 cannot enter the left eye of the user, and hence the crosstalk between the left-eye image displayed by the first area 211 and the right-eye image displayed by the second area 212 can be avoided.

For instance, in the VR device 100 provided by one embodiment of the present disclosure, the cabin 120 further includes a light-shielding plate 122 disposed between the first optical system 111 and the second optical system 112.

For instance, the light-shielding plate 122 can prevent the left-eye image displayed by the first area 211 of the display 210 from entering the right eye of the user or prevent the right-eye image displayed by the second area 212 from entering the left eye of the user, and hence reduce the crosstalk between the left-eye image displayed by the first area 211 and the right-eye image displayed by the second area 212.

For instance, when used, the display 210 is placed close to the light-shielding plate 122, so that the size of a gap between the light-shielding plate and the display can be reduced, and hence the crosstalk between the left-eye image displayed by the first area 211 and the right-eye image displayed by the second area 212 can be reduced.

For instance, in the VR device 100 provided by one embodiment of the present disclosure, the cabin 120 is made of an opaque material. For instance, the cabin being made from the opaque material does not indicate that all the components of the cabin are made of the opaque material, as long as, for instance, a housing or an outside surface of the cabin is made of the opaque material.

For instance, as the cabin 120 is made of the opaque material, the interference of ambient light can be avoided, and hence the user can obtain good viewing experience.

For instance, the cabin 120 is provided with a window (not illustrated in the figure) for the transmission of imaged light of the optical system. Light emitted by the display 210 of the electronic device is transmitted to the outside of the cabin 120 through the window after being imaged by the optical system 110, and for instance, may reach the eye of the user. For instance, the window may be an opening of the cabin or a transparent area of the cabin.

For instance, in the VR device 100 provided by one embodiment of the present disclosure, the cabin 120 further includes a light shield 123. For instance, the light shield 123 is disposed on a side of the optical system 110 opposite to the side provided with the electronic device. For instance, the light shield 123 may be a tubular structure connected to the cabin 120, and an end of the light shield connected with the cabin may encircle the window of the cabin 120.

For instance, the light shield 123 is provided with a shape matched with the facial contour of the user on one side close to the face of the user, so that ambient light cannot be mixed when light emitted from the optical system 110 is transmitted to the eye of the user, and hence the user can obtain good viewing experience. The light shield 123, for instance, is made from opaque elastic materials such as rubber.

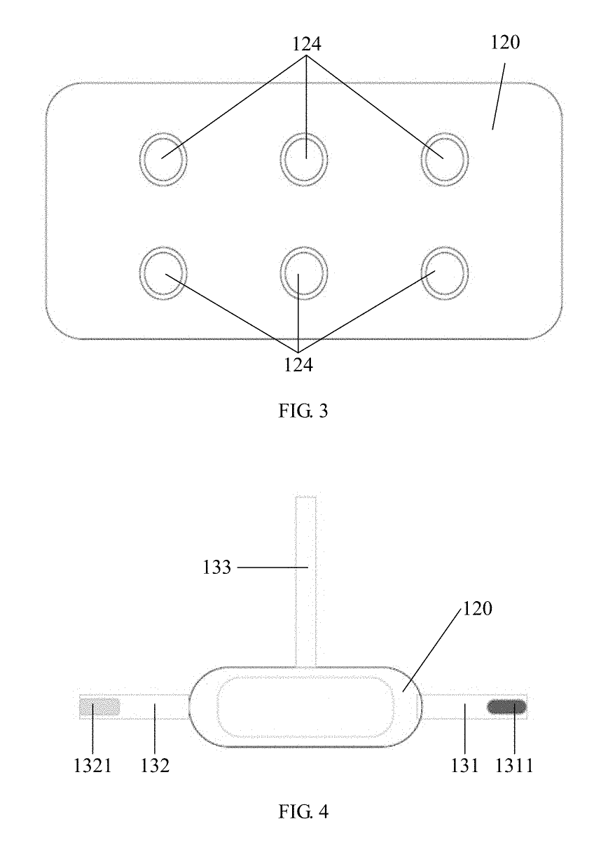

For instance, as illustrated in FIGS. 2 and 3, in the VR device 100 provided by one embodiment of the present disclosure, the cabin 120 further includes an elastic fixing member 124; a first end of the elastic fixing member 124 is connected with the cabin 120; and a second end of the elastic fixing member 124 may be connected with the electronic device 200, for instance, the second end of the elastic fixing member 124 is in compression joint with the electronic device 200.

For instance, that the second end of the elastic fixing member 124 may be in compression joint with the electronic device 200 refers to that: after the electronic device is mounted, the second end of the elastic fixing member makes contact with the electronic device; the elastic fixing member is subjected to elastic deformation; and a force is applied to the electronic device through the second end of the elastic fixing member, so that the electronic device can be fixed.

For instance, the elastic fixing member 124 may be configured to fix the electronic device with different dimensions.

For instance, the elastic fixing member 124 is disposed on four sidewalls in the cabin 120 or at positions on one side opposite to the display of the electronic device, and hence can fix the electronic device at 3D spatial positions. FIG. 2 illustrates the elastic fixing member 124 disposed on the four sidewalls in the cabin 120, and FIG. 3 illustrates the elastic fixing member disposed at the positions on one side opposite to the display of the electronic device. The elastic fixing member, for instance, includes a spring, a rubber pad or a combination thereof. It should be noted that the number of the elastic fixing member is not limited to the case as illustrated in FIGS. 2 and 3 and the elastic fixing member with different numbers can be arranged according to actual demands.

For instance, in the VR device 100 provided by one embodiment of the present disclosure, the cabin 120 is provided with a cabin cover 125 which is capable of being opened or closed. The open-close type cabin cover 125 facilitates the assembly and disassembly of the electronic device.

For instance, in the VR device 100 provided by one embodiment of the present disclosure, the cabin 120 further includes a heat dissipation structure (not illustrated in the figure); a first side of the heat dissipation structure makes contact with the electronic device; and a second side of the heat dissipation structure is disposed on an outside surface of the cabin.

For instance, the heat dissipation structure is configured to dissipate the heat of the electronic device and hence avoids poor operation such as the crash of the electronic device due to heating. The heat dissipation structure is made from metallic materials and may be integrally formed with the cabin cover, or the cabin cover is taken as the heat dissipation structure and made from, e.g., the metallic materials.

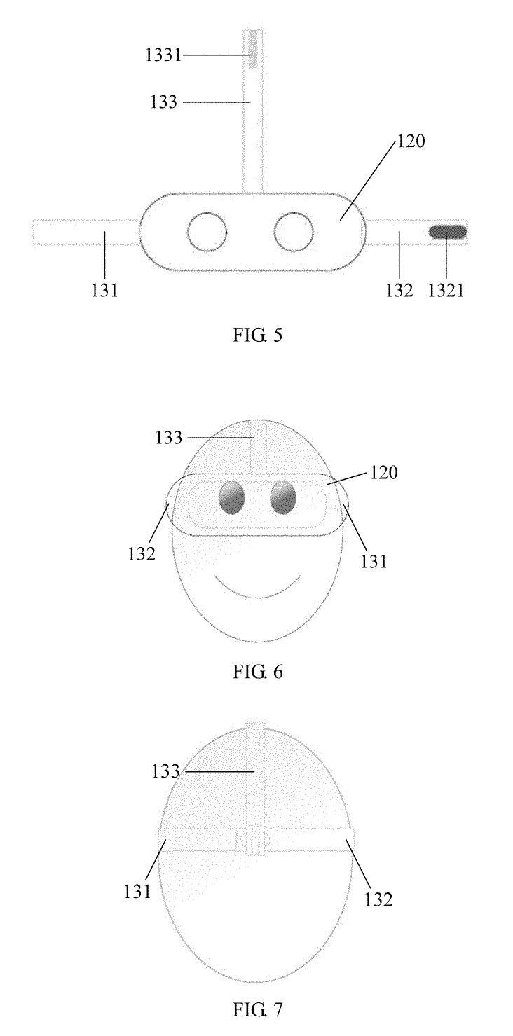

For instance, as illustrated in FIGS. 4 and 5, the VR device provided by one embodiment of the present disclosure further comprises a head mounting member. The head mounting member includes bands which are at least connected with two opposite sides of the cabin.

For instance, as illustrated in FIGS. 4 and 5, in the VR device 100 provided by one embodiment of the present disclosure, the head mounting member includes a first band 131, a second band 132 and a third band 133, wherein a first end of the first band 131 is connected with a first side of the cabin 120; a first end of the second band 132 is connected with a second side of the cabin 120; a first end of the third band 133 is connected with the top of the cabin 120; and the second end of the first band 131, the second end of the second band 132 and the second end of the third band 133 are respectively provided with a first connecting member 1311, a second connecting member 1321 and a third connecting member 1331, and are capable of being connected with each other through the first connecting member 1311, the second connecting member 1321 and the third connecting member 1331.

For instance, an adhered layer (or an adhesive layer) 1311 is disposed on the outside of the second end of the first band 131; an adhesive layer and an adhered layer 1321 are respectively disposed on the inside and the outside of the second end of the second band 132; and an adhesive layer (or an adhered layer) 1331 is disposed on the inside of the second end of the third band 133. It should be noted that the embodiment of the present disclosure includes the case that the first connecting member, the second connecting member and the third connecting member are the adhesive layer or the adhered layer but not limited thereto. The first connecting member, the second connecting member and the third connecting member may also be members having connecting function such as snap fasteners, zippers and latch hooks.

For instance, as illustrated in FIGS. 6 and 7, the user can wear the VR device through the head mounting member. When used, firstly, the first band 131 goes to the back of the head along one side of the head of the user; secondly, the second band 132 goes to the back of the head along the other side of the user and is connected with the first band 131 through, for instance, the adhered layer 1311 and the adhesive layer 1321; and finally, the third band 133 goes to the back of the head along the top of the head of the user and is connected with the second band 132 through, for instance, the adhered layer 1321 and the adhesive layer 1331, so that the complete adhesion and fixation of the VR device in the 3D direction when worn on the head of the human body can be achieved.

For instance, the head mounting member is simple and convenient to use; accurate adhesion adjustment may be performed according to different heads of different human bodies; the adjustable range is large; the cost is low; and the comfortableness of the wearer can be improved.

Description is given above to the head mounting member by taking the structures as illustrated in FIGS. 4 and 5 as an example. However, the embodiment of the present disclosure is not limited to the above specific fixing member, and any appropriate head mounting member may be adopted.

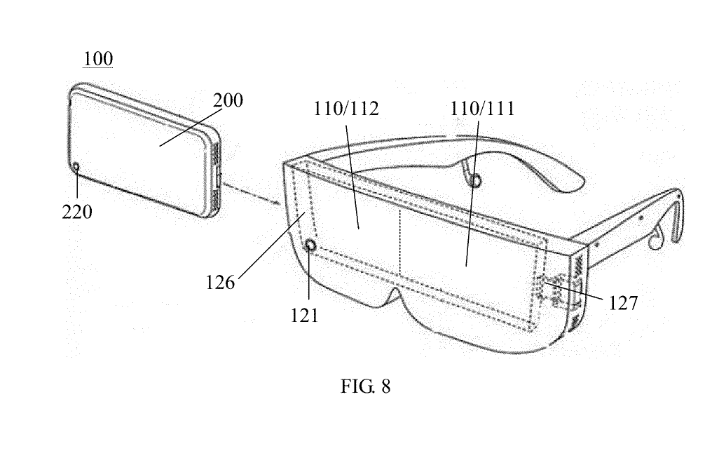

For instance, as illustrated in FIG. 8, another embodiment of the present disclosure provides a VR device 100, which comprises an optical system 110 and a cabin 120. An electronic device 200 provided with a display 210 may be detachably mounted in the cabin 120. The optical system 110 is used for the imaging of light emitted by the display 210.

For instance, in the VR device 100 provided by one embodiment of the present disclosure, the optical system 110 includes a first optical system 111 and a second optical system 112; light emitted by a first area 211 of the display 210 is imaged to a left eye of a user through the first optical system 111; and light emitted by a second area 212 of the display 210 is imaged to a right eye of the user through the second optical system 112.

For instance, in the VR device 100 provided by one embodiment of the present disclosure, the cabin 120 is also provided with a transmission member 121 matched with a camera 220 of the electronic device 200; the camera 220 of the electronic device 200 may acquire an ambient image through the transmission member 121; and the electronic device 200 generates a composite image by overlapping the ambient image and a virtual scene and displays the composite image on the display 210.

For instance, the transmission member 121 is an opening, a polarizer, a lens, a polarizer or other light-transmitting members.

For instance, the electronic device 200 acquires the ambient image through the camera 220 and generates the composite image by overlapping the ambient image and characters in the virtual scene. The composite image, for instance, may be the composition of the characters in the virtual scene and the real-world ambient image, so that the user can sense that the characters in the virtual scene are immersed in the display environment. The display 210, for instance, may display the composite images corresponding to the left eye and the right eye of the user after 3D processing in the first area 211 and the second area 212 respectively, so that the user can sense the composite images with 3D effect.

For instance, in the VR device 100 provided by one embodiment of the present disclosure, the focal length, the object distance and the interpupillary distance of the first optical system 111 and the second optical system 112 are adjustable.

For instance, in the VR device 100 provided by one embodiment of the present disclosure, both the first optical system 111 and the second optical system 112 are eyepiece systems.

For instance, in the VR device 100 provided by one embodiment of the present disclosure, the cabin 120 further includes a built-in camera, a motor and a processor; the built-in camera is configured to acquire an eye image of the user; the processor is configured to acquire proper focal length, object distance and interpupillary distance by analyzing the eye image; and the processor is also configured to control the motor to automatically adjust the focal length, the object distance and the interpupillary distance of the first optical system 111 and the second optical system 112.

For instance, in the VR device 100 provided by one embodiment of the present disclosure, the first optical system 111 and the second optical system 112 also respectively include a first aperture stop and a second aperture stop.

For instance, in the VR device 100 provided by one embodiment of the present disclosure, the cabin 120 is made of an opaque material.

For instance, in the VR device 100 provided by one embodiment of the present disclosure, a notch 126 is formed on one side of the cabin 120.

For instance, as illustrated in FIG. 8, when used, the electronic device 200 is pushed in from the notch 126 and fixed through a member such as a snap fastener disposed in the notch. The arrangement of the notch 126 facilitates the assembly and disassembly of the electronic device 200.

For instance, in the VR device 100 provided by one embodiment of the present disclosure, the cabin 120 further includes an interface 127 for audio transmission with the electronic device 200.

For instance, when used, the interface 127 is connected with the electronic device 200 and configured to acquire audio signals from the electronic device 200. The audio signals are transmitted to an earphone near the ear of the user through an earphone cord, and the earphone plays audio according to the audio signals. The interface 127 for audio transmission provides convenience for the user to acquire audio information, does not need to independently wear the earphone, and hence improves the experience of the user.

For instance, in the VR device 100 provided by one embodiment of the present disclosure, the cabin 120 further includes a heat dissipation structure (not illustrated in the figure); a first side of the heat dissipation structure makes contact with the electronic device; and a second side of the heat dissipation structure is disposed on an outside surface of the cabin.

For instance, the VR device 100 provided by one embodiment of the present disclosure further comprises a head mounting member. As description is given above to the head mounting member in the foregoing embodiment, no further description will be given here.

The embodiment of the present disclosure further provides a VR system, which comprises the VR device provided by any embodiment of the present disclosure and an electronic device provided with a display. The electronic device is mounted in the cabin.

For instance, in the VR system provided by one embodiment of the present disclosure, the electronic device is a smart mobile phone or a tablet computer.

For instance, the VR system provided by one embodiment of the present disclosure further comprises a battery which is connected with a camera, a motor and a processor. The battery, for instance, provides electricity for the camera, the motor and the processor.

For instance, when used, the battery may be connected with a charging interface of the electronic device and configured to charge the electronic device.

It should be noted that the embodiment of the present disclosure includes but not limited to the case that the battery is provided, and members having power supply function such as an external power source may also provide electricity for the camera, the motor, the processor and the electronic device.

The VR device and the VR system provided by the embodiment of the present disclosure utilize hardware and software resources of the electronic device provided with the display, do not require an independent display, reduce the hardware cost, and meanwhile, provide convenience for acquiring application resources.

The foregoing is only the preferred embodiments of the present disclosure and not intended to limit the scope of protection of the present invention. The scope of protection of the present invention shall be defined by the appended claims.

The application claims priority to the Chinese patent application No. 201610166649.X, filed Mar. 22, 2016, the disclosure of which is incorporated herein by reference as part of the application.

1. A virtual reality (VR) device, comprising an optical system and a cabin, wherein the cabin is configured such that an electronic device provided with a display can be detachably mounted therein; and the optical system is configured for imaging of light emitted by the display.

2. The VR device according to claim 1, wherein the optical system includes a first optical system and a second optical system; light emitted by a first area of the display is imaged to a left eye of a user through the first optical system; and light emitted by a second area of the display is imaged to a right eye of the user through the second optical system.

3. The VR device according to claim 1, wherein the cabin is also provided with a transmission member matched with a camera of the electronic device; the camera of the electronic device is capable of acquiring an ambient image through the transmission member; and the electronic device is configured to generate a composite image by overlapping the ambient image and a virtual scene and display the composite image on the display.

4. The VR device according to claim 2, wherein a focal length, an object distance and an interpupillary distance of the first optical system and the second optical system are adjustable.

5. The VR device according to claim 2, wherein both the first optical system and the second optical system are eyepiece systems.

6. The VR device according to claim 4, wherein the cabin further includes a built-in camera, a motor and a processor; the built-in camera is configured to acquire an eye image of the user; the processor is configured to acquire proper focal length, object distance and interpupillary distance by analyzing the eye image; and the processor is also configured to control the motor to automatically adjust the focal length, the object distance and the interpupillary distance of the first optical system and the second optical system.

7. The VR device according to claim 2, wherein the first optical system and the second optical system further include a first aperture stop and a second aperture stop respectively.

8. The VR device according to claim 2, wherein the cabin further includes a light-shielding plate disposed between the first optical system and the second optical system.

9. The VR device according to claim 1, wherein the cabin is made of an opaque material.

10. The VR device according to claim 1, wherein the cabin is provided with a window for transmission of imaged light of the optical system.

11. The VR device according to claim 10, further comprising a light shield, wherein the light shield is connected with the cabin and disposed on a side of the optical system opposite to a side provided with the electronic device.

12. The VR device according to claim 1, wherein the cabin further includes an elastic fixing member; a first end of the elastic fixing member is connected with the cabin; and a second end of the elastic fixing member is capable of being connected with the electronic device.

13. The VR device according to claim 1, wherein the cabin is provided with a cabin cover which is capable of being opened or closed, or a notch is formed on a side of the cabin.

14. The VR device according to claim 1, wherein the cabin further includes an interface for audio transmission with the electronic device.

15. The VR device according to claim 1, wherein the cabin further includes a heat dissipation structure; a first side of the heat dissipation structure makes contact with the electronic device; and a second side of the heat dissipation structure is disposed on an outside surface of the cabin.

16. The VR device according to claim 1, further comprising a head mounting member, wherein the head mounting member includes bands which are at least connected with two opposite sides of the cabin.

17. The VR device according to claim 16, wherein the head mounting member includes a first band, a second band and a third band, in which a first end of the first band is connected with a first side of the cabin; a first end of the second band is connected with a second side of the cabin; a first end of the third band is connected with a top of the cabin; and a second end of the first band, a second end of the second band and a second end of the third band are respectively provided with a first connecting member, a second connecting member and a third connecting member, and are capable of being connected with one another through the first connecting member, the second connecting member and the third connecting member.

18. A VR system, comprising the VR device according to claim 1 and an electronic device provided with a display, wherein the electronic device is mounted in the cabin.

19. The VR system according to claim 18, wherein the electronic device is a smart mobile phone or a tablet computer.

20. The VR system according to claim 18, wherein the cabin further includes a built-in camera, a motor and a processor; the built-in camera is configured to acquire an eye image of the user; the processor is configured to acquire proper focal length, object distance and interpupillary distance by analyzing the eye image; and the processor is also configured to control the motor to automatically adjust the focal length, the object distance and the interpupillary distance of the first optical system and the second optical system, and
the VR system further comprises a battery, and the battery is electrically connected with the built-in camera, the motor and the processor.
